(19) United States
(12) Patent Application Publication
(10) Pub. No.: US 2021/0150377 A1
(43) Pub. Date: May 20, 2021

(54) INTELLIGENT DRESSING REMINDING DEVICE, WARDROBE AND CONTROL METHOD THEREOF

(71) Applicant: QINGDAO HAIER WASHING MACHINE CO., LTD., Shandong (CN)

(72) Inventors: Yang LI, Shandong (CN); Sheng XU, Shandong (CN); Hai SHU, Shandong (CN); Junming YIN, Shandong (CN); Zhenxing HUANG, Shandong (CN); Tao ZHANG, Shandong (CN)

(73) Assignee: QINGDAO HAIER WASHING MACHINE CO., LTD., Shandong (CN)

(21) Appl. No.: 16/618,649

(22) PCT Filed: Jun. 1, 2018
(86) PCT No.: PCT/CN2018/089444

§ 371 Date: Jul. 23, 2020

(30) Foreign Application Priority Data
Jun. 1, 2017 (CN) 201710404299.0
Jun. 12, 2017 (CN) 201710439745.1

(51) Int. Cl. G06N 5/04; G06N 20/00; G06F 16/28

(52) U.S. Cl. CPC G06N 5/04; G06F 16/288; G06N 20/00

(57) ABSTRACT

The present disclosure discloses an intelligent dressing prompt device capable of being arranged on a clothes accommodating device. The intelligent dressing prompt device includes a near-field identification module, which is used for reading clothes information stored in electronic labels fixed on clothes in the clothes accommodating device; and a control module, which is connected with the near-field identification module for obtaining relevant dressing recommendation information to prompt a user according to the clothes information obtained by the near-field identification module. In the present disclosure, the relevant dressing recommendation information is obtained to prompt the user according to the clothes situation in the clothes accommodating device to facilitate people's life and help people to select suitable dressing clothes; and a wardrobe with the intelligent dressing prompt device and a control method of the wardrobe are also provided.

### TECHNICAL FIELD

The present disclosure relates to the field of household appliances, in particular to an intelligent dressing prompt device, a wardrobe and a control method of the wardrobe.

### BACKGROUND

Existing clothes accommodating devices are only used for placing user's clothes, and once it accommodates many clothes, the user needs to select the appropriate one from the large number of clothes when the weather changes. However, since the clothes are all stored in the accommodating device, the user cannot quickly get all suitable clothes, causing some clothes stored in a wardrobe overlooked by the user and left unused in the accommodating devices.

In another aspect, the wardrobe is a commonly used clothes accommodating device.

In the prior art, there are patents of intelligent wardrobes, such as: the utility model patent with application No. 201020539459.6 disclosed an intelligent wardrobe, which includes a wardrobe body (1), on which an RFID reader (4), a display (5) and an RFID antenna (3) which, after electrified, generates magnetic field covering the whole wardrobe body (1) and detects the clothes provided with RFID chips (6) in the wardrobe body (1); the RFID antenna (3) is electrically connected with the RFID reader (4), the RFID reader (4) is electrically connected with the display (5), and the RFID reader (4) and the display (5) are electrically connected with a power supply. The intelligent wardrobe can display the clothes with the RFID chips in the wardrobe. However, the patent only discloses how to read information of the clothes in the wardrobe, but not to recommend dressing for the user according to the clothes information, so the user can only check the clothes information in the display and select the appropriate clothes, which is also cumbersome.

In view of this, the present disclosure is proposed.

### SUMMARY

The technical problem to be solved by the present disclosure is to overcome the shortcomings of the prior art, and provide an intelligent dressing prompt device capable of being arranged on a clothes accommodating device, to read clothes information in the accommodating device and then obtain relevant dressing recommendations for the user according to weather forecast information.

In order to solve the above technical problems, the basic concept of the technical solution adopted by the present disclosure is as follows:

the intelligent dressing prompt device capable of being arranged on the clothes accommodating device, including:

a near-field identification module, used for reading the clothes information stored in electronic labels fixed on the clothes in the clothes accommodating device;

a control module, connected with the near-field identification module to obtain relevant dressing recommendation information and prompt the user according to the clothes information obtained by the near-field identification module.

Preferably, the intelligent dressing prompt device also includes a communication module for communication and connection to obtain dressing condition information on which the dressing recommendations are based.

Preferably, the communication module communicates and connects for obtaining current dressing fashion information and/or weather precast information and/or the dressing request information input by the user, and sending it to the control module as the dressing condition information for the control module to obtain the dressing recommendations;

preferably, the dressing request information input by the user includes clothes application scene information, season information and clothes matching and style information.

Preferably, the intelligent dressing prompt device also includes a cloud server, the control module is connected with the cloud server through the communication module, and the cloud server communicates and connects with the intelligent terminal; and the cloud server is used to send the dressing fashion information and/or the weather precast information to the communication module and/or the intelligent terminal, then receive the relevant dressing recommendation information sent by the control module and push it to the intelligent terminal to prompt the user.

The present disclosure also provides a wardrobe provided with the intelligent dressing prompt device simultaneously, including a wardrobe body for storing the clothes, the near-field identification module is arranged inside the wardrobe body, and may transmit a radio frequency signal covering the entire interior space of the wardrobe body, the control module and the communication module are arranged inside or outside the wardrobe body.

In the above solution, for example, the near-field identification module may be an RFID reader, while the electronic labels are RFID labels, and the RFID reader continuously sends signals with certain frequency through an antenna to cover the entire wardrobe interior. When entering a magnetic field, the RFID labels send clothes information codes stored in chips by energy obtained by an induction current, and then the RFID reader reads and decodes the information and transmits data to the control module for relevant data processing.

Preferably, the wardrobe also includes a display device for displaying the dressing recommendation information.

Preferably, the wardrobe also includes a loudspeaker, electrically connected with the control module for prompting the user through voice to check the dressing recommendation information and/or broadcasting the dressing recommendation information through the voice.

In the above solution, setting the loudspeaker helps to increase the intelligence level of the wardrobe, thus realizing good user experience.

The present disclosure also provides a control method applied to the wardrobe, including: controlling, by the control module, the near-field identification module to obtain the clothes information of all the clothes in the wardrobe after receiving the dressing condition information; and performing data analysis and processing according to the dressing condition information and all the clothes information to obtain the dressing recommendation information that meets the dressing condition and prompt the user.

Preferably, the dressing condition information includes the clothes application scene information input by the user, and the control module obtains the dressing recommendations according to the clothes application scene information;

preferably, the dressing condition information also includes the current dressing fashion information and/or the weather precast information obtained by the communication module.

Preferably, the control module obtains a plurality of dressing schemes for the user to select according to the dressing condition information, then analyzes the dressing preference of the user according to the user's selection result, and optimizes subsequent recommended dressing schemes according to the dressing preference of the user.

Preferably, the optimized subsequent recommended dressing scheme includes: the control module preferentially recommends the dressing scheme preferred by the user according to the dressing preference of the user;

preferably, the control module arranges the dressing schemes in descending order according to the preference of the user and recommends them to the user.

Preferably, the control module also recommends new style clothes preferred by the user to the user according to the preference of the user, and prompts the user to select and purchase;

preferably, before the relevant dressing recommendation information is obtained, the control module recommends the new style clothes preferred by the user to the user according to new style clothes information obtained by the communication module, and prompts the user to select and purchase.

In the present disclosure, the relevant dressing recommendation information is obtained by matching the detected clothes information in the clothes accommodating device with the dressing condition information to prompt the user, thereby facilitating people's life, helping people to select suitable dressing clothes, and saving a large amount of time for the user in the event of selecting the clothes.

The specific embodiments of the present disclosure will be described in further detail in combination with the accompanying drawings.

### BRIEF DESCRIPTION OF THE DRAWINGS

As a part of the application, the accompanying drawings are used to provide further understanding of the present disclosure. The schematic embodiments and descriptions of the present disclosure are used to explain the present disclosure, and do not constitute an improper limitation on the present disclosure. Obviously, the drawings in the following description only correspond to some embodiments. For those of ordinary skilled in the art, other drawings can be obtained according to these drawings without any creative work. In the accompanying drawings:

FIG. 1 is a control flow chart of a control method of a wardrobe in embodiment 3 of the present disclosure; and

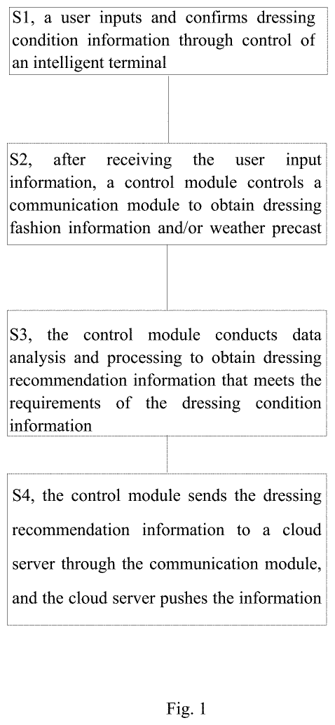

FIG. 2 is a control flow chart of a control method of a wardrobe in embodiment 4 of the present disclosure.

It should be noted that these drawings and text descriptions are not intended to limit the conceptual scope of the present disclosure in any way, but to illustrate the concept of the present disclosure for those skilled in the art by referring to specific embodiments.

### DETAILED DESCRIPTION

To make purposes, technical solutions and advantages of the embodiments of the present disclosure clearer, the technical solutions in the embodiments will be described clearly and completely in combination with the drawings in the embodiments of the present disclosure. The following embodiments are used to explain the present disclosure, but not to limit the scope of the present disclosure.

In the descriptions of the present disclosure, it should be noted that the orientation or position relationship of the terms “up”, “down”, “inside”, “outside” and other indications is based on the orientation or position relationship shown in the drawings, and is only for the convenience of describing the present disclosure and simplifying the descriptions, rather than indicating or implying that referred devices or elements must have the specific orientation, or be constructed and operated in the specific orientation, Therefore, it cannot be understood as a limitation on the present disclosure.

In the descriptions of the present disclosure, it should be noted that unless otherwise specified and defined, the terms “installation” and “connection” should be understood in a broad sense. For example, it can be a fixed connection, a detachable connection, or an integrated connection; it can be a mechanical connection, or an electrical connection; and it can be a direct connection, or an indirect connection through a medium. For those of ordinary skilled in the art, the specific meanings of the above terms in the present disclosure can be understood in specific situations.

### Embodiment 1

The embodiment provides an intelligent dressing prompt device capable of being arranged on a clothes accommodating device, including:

a near-field identification module, used for reading clothes information stored in electronic labels fixed on clothes in the clothes accommodating device;

a communication module, used for communication and connection to obtain dressing condition information;

a control module, connected with the near-field identification module and the communication module for data analysis and processing according to the dressing condition information obtained by the communication module and the clothes information read by the near-field identification module to obtain relevant dressing recommendation information and prompt the user.

Preferably, the dressing condition information includes external factor information affecting dressing and subjective dressing requirements of the user. For example, the user may input subjective dressing requirement information through an intelligent terminal, such as clothes application scene information, season information, dressing style information, etc.

Preferably, a cloud server is further provided, wherein the control module communicates and connects with the cloud server through the communication module, the cloud server communicates and connects with the intelligent terminal, and the control module pushes the obtained relevant dressing recommendation information to the intelligent terminal through the cloud server to prompt the user.

Preferably, the electronic labels store clothes information codes corresponding to clothes, which are total information codes formed by series combination of sub codes representing different attribute information of the clothes; the control module receives the clothes information codes stored in each electronic label sent by the near-field identification module, then separately divides each clothes information code into the sub codes, and matches specific information of each sub code to obtain the specific clothes information represented by each clothes information code.

In the above solution, the clothes information codes refer to that the clothes information is divided into a variety of attribute information according to the attributes and stored in the electronic labels in the form of codes, which is conducive to normalizing the storage mode of clothes information, so that all the clothes can be stored and defined. The method is simple, practical and worth promoting. In another aspect, storing the data information in the form of codes saves the storage capacity for the clothes information. Compared with an existing storage mode, this solution stores more clothes information in a smaller storage space.

In another aspect, after reading the clothes information code, the near-field recognition module may divide the information code into the several sub codes according to different attributes it represents and translate them separately to obtain the final specific clothes information.

Preferably, the intelligent dressing prompt device also includes a storage module for storing the corresponding relationship between each specific sub code and the specific dressing attribute information represented by each specific sub code, and the control module matches out the specific attribute information represented by each sub code in the clothes information code according to the corresponding relationship.

In another aspect, the clothes information codes stored in the electronic labels on the clothes include the sub codes, each of which adopts a code format of different length according to the category number of the attribute information represented by it. Length format parameters adopted by each sub code are stored on the intelligent dressing prompt device. The near-field identification module divides the clothes information codes into the sub codes according to the length format parameters after obtaining the clothes information codes.

In the above solution, each sub code adopts the code format of different length according to the category number of the attribute information represented by it, design is reasonable, and the storage space is further saved. For example, the clothes include material information and manufacturer information, existing material category data of the clothes are far less than the number of manufacturers. Therefore, it is more reasonable that the storage space allocated to the manufacturer information is larger than that of the material information during allocation of the storage space. Of course, the storage space allocated to all kinds of data information may be larger than the total category number of the data information in existence, and there is space left for further development of the information in this field. For example, if there are M existing categories that may be used as materials, the storage space allocated to the material data may store more than M different codes, so that in this storage space, all the existing fabric material information may be completely represented, and the spare space should be left for possible larger novel fabric materials in the future.

In another aspect, this solution is not limited to allocated storage spaces of all kinds of attribute information to be necessarily larger than the category number of all kinds of the existing attribute information it, and all kinds of the attribute information may be further divided into multiple subcategories according to a certain rule. In this way, the storage capacity of the storage space allocated to all kinds of the attribute information only needs to be sufficient to distinguish their own multiple subcategories. For example: the fabric material information includes jute, ramie, wool, rabbit hair, silk, spider silk, polyester, nylon, acrylic, etc., then each material can be divided into hemp materials (the jute, the ramie), wool materials (the wool, the rabbit hair), silk materials (the silkworm silk, the spider silk), chemical fiber materials (the polyester, the nylon, the acrylic) according to the material attributes, hence, the fabric material information will be allocated with two bits, such as 00 for the hemp materials, 01 for the wool materials, 10 for the silk materials and 11 for the chemical fiber materials (the example is only for explanation, not for defining the technical solution of the present disclosure).

Preferably, the sub codes include material information codes, color information codes, category information codes, specification information codes, and manufacturer information codes, and each information code is stored in the electronic labels sequentially from high bit to low bit. After reading the clothes information codes, the near-field identification module sends the clothes information codes to the control module, and then the control module successively divides the clothes information codes from high bit to low bit into the material information codes, the color information codes, the category information codes, the specification information codes and the manufacturer information codes, and translates the clothes attribute information represented by each sub code in turn.

The control module matches the clothes that meet the requirements of the dressing condition information according to the dressing condition information and the specific clothes attribute information represented by each sub code.

### Embodiment 2

The embodiment provides a wardrobe provided with the intelligent dressing prompt device in embodiment 1. The wardrobe includes a wardrobe body for storing clothes; a near-field identification module is arranged inside the wardrobe body and may transmit a radio frequency signal covering the entire interior space of the wardrobe body, and a control module and a communication module are arranged inside or outside the wardrobe body.

In the above solution, for example, a near-field identifier can be an RFID reader and electronic labels can be RFID labels. The RFID reader continuously sends signals with certain frequency through an antenna. When entering a magnetic field, the RFID labels send clothes information codes stored in chips by the energy obtained by an induction current, then the RFID reader reads the clothes information codes and transmits them to the control module for relevant data processing.

Preferably, an outer surface of the wardrobe body is provided with a display device for displaying relevant dressing recommendation information to prompt a user;

Preferably, the wardrobe also includes a loudspeaker, which is electrically connected with the control module for prompting the user through voice to check the dressing recommendation information and/or broadcasting the dressing recommendation information through the voice.

In the above solution, setting the loudspeaker helps to increase the intelligence level of the wardrobe, thus realizing good user experience.

### Embodiment 3

The embodiment provides a control method applied to the wardrobe in embodiment 2, including:

controlling, by a control module, a near-field identification module to obtain clothes information of all clothes in the wardrobe after receiving dressing condition information; and performing data analysis and processing according to the dressing condition information and all the clothes information to obtain the dressing recommendation information that meets the dressing condition and prompt a user.

Preferably, the dressing condition information includes clothes application scene information input by the user, and the control module obtains dressing recommendations according to the clothes application scene information;

preferably, the dressing condition information also includes current dressing fashion information and/or weather precast information obtained by a communication module.

Preferably, the control module obtains a plurality of dressing schemes for the user to select according to the dressing condition information, then analyzes the dressing preference of the user according to the user's selection result, and optimizes the subsequent recommended dressing schemes according to the dressing preference of the user.

Preferably, the optimized subsequent recommended dressing scheme includes: the control module preferentially recommending the dressing scheme preferred by the user according to the dressing preference of the user;

preferably, the control module arranges the dressing schemes in descending order according to the preference of the user and recommends them to the user.

Preferably, the control module also recommends new style clothes preferred by the user to the user according to the preference of the user, and prompts the user to select and purchase;

preferably, before the relevant dressing recommendation information is obtained, the control module recommends the new style clothes preferred by the user to the user according to the new style clothes information obtained by the communication module, and prompts the user to choose and purchase.

Specifically, in the embodiment, the control method of the wardrobe includes the following steps:

S1, the user inputs and confirms the dressing condition information through control of an intelligent terminal;

S2, after receiving the information input by the user, the control module controls the communication module to obtain the dressing fashion information and/or the weather precast information and/or other dressing condition information;

S3, the control module conducts data analysis and processing to obtain the dressing recommendation information that meets the requirements of the dressing condition information;

S4, the control module sends the dressing recommendation information to a cloud server through the communication module, and the cloud server pushes the information to the intelligent terminal after receiving the information.

### Embodiment 4

Embodiment 4 describes the control process where dressing condition information includes weather precast information on the basis of embodiment 3:

after a control module receives a user's instruction (requesting dressing recommendations), a communication module is controlled to obtain the weather precast information (i.e. the dressing condition information), a near-field identification module is controlled to obtain clothes information of all clothes in a wardrobe for data analysis and processing according to the weather precast information and the clothes information to obtain dressing recommendation information to prompt a user.

Preferably, the control module generates the dressing recommendation information and/or dressing matching recommendation information and/or clothes purchase recommendation information in combination with the clothes information according to season information and/or temperature information and/or rainfall capacity information and/or snowfall capacity information in the weather precast information, and pushes the recommendation information to a display device or an intelligent terminal to prompt the user.

In the above solution, for example, the control module selects the clothes in the wardrobe according to the season information and the temperature information of the day so as to be matched with the season and the temperature to prompt the user to dress. The control module may also obtain the future weather conditions of the day according to the rainfall capacity information and temperature information in the weather precast information and prompt the user to select thicker clothes as the target clothes according to the weather conditions.

Preferably, the control module prompts the user with the dressing recommendation information at a fixed time point every day, for example, in the morning, the control module prompts the user to wear the recommended clothes through the intelligent terminal and/or the display device and/or a loudspeaker.

Further, in order to prevent disturbing rest of the user, the wardrobe is provided with a trigger button for activating the control module while waiting for the user to activate. The control module controls the communication module to obtain the weather precast information and controls the near-field identification module to obtain the clothes information of all the clothes in the wardrobe for data analysis and processing according to the weather precast information and all the clothes information to obtain the dressing recommendation information and prompt the user through the display device and/or the loudspeaker/the intelligent terminal.

Preferably, the control module judges whether the weather precast information meets the preset triggering conditions, and if the result is yes, the control module obtains the recommendation information to prompt the user;

preferably, judging whether the weather precast information meets the preset triggering conditions by the control module includes: calculating whether the temperature change range or the rainfall capacity change range or the snowfall capacity change range reaches the preset change range in a period to come according to the weather precast information; if the result is yes, judging that the weather precast information meets the preset triggering conditions, or otherwise, judging that the weather information does not meet the preset triggering conditions.

In the above solution, when the weather changes little, the user does not need to change dressing. Therefore, at this time, it is not necessary to obtain the dressing recommendations and prompt the user, the user will not be disturbed, and the user experience is good. When the weather changes greatly, the dressing recommendations will be obtained to prompt the user, which reflects the intellectualization of the wardrobe and highlights the intelligent prompt function of the wardrobe rather than mechanical prompts of redundant information.

Preferably, obtaining the dressing recommendation information through data analysis and processing according to the weather precast information and the clothes information to prompt the user includes:

generating, by the control module, corresponding dressing parameters according to the weather precast information, wherein the dressing parameters include different attribute information of the clothes; and comparing and matching, by the control module, the dressing parameters with the clothes information of all the clothes in the wardrobe, then obtaining at least one clothes with the clothes information matched with the dressing parameters as the target clothes, and pushing the clothes information of the target clothes to the user for dressing recommendation.

Preferably, when the target clothes with the clothes information matched with the dressing parameters is not obtained, the user is prompted to purchase or add the clothes, and the dressing parameters are pushed to the user as the basis information for purchasing.

At this time, the wardrobe may recommend the user to purchase the clothes and recommend user purchase recommendations according to the current popular trend for truly recommending the clothes needed by the user according to the actual situation of the user.

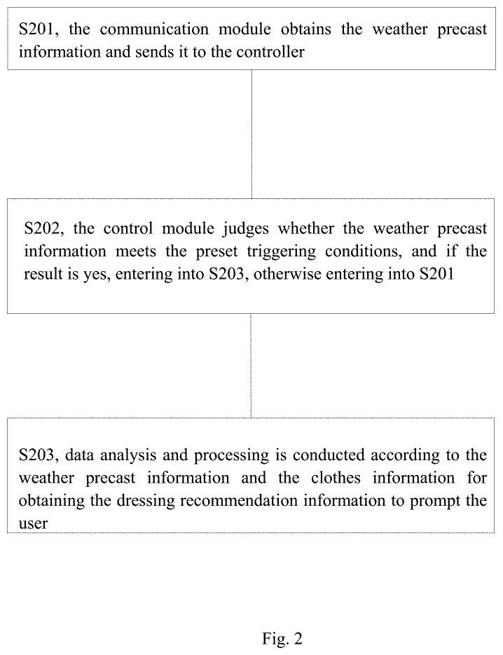

In conclusion, as shown in FIG. 2, the control method of the wardrobe includes the following steps:

S201, the communication module obtains the weather precast information and sends it to the control module;

S202, the control module judges whether the weather precast information meets the preset triggering conditions, and if the result is yes, entering into S203, otherwise entering into S201;

S203, data analysis and processing is conducted according to the weather precast information and the clothes information for obtaining the dressing recommendation information to prompt the user.

In this embodiment, the detected clothes information in the clothes accommodating device is matched with the weather precast information to obtain the relevant dressing recommendation information to prompt the user, which facilitates people's life, helps people to select suitable dressing clothes, and saves a lot of time for the user in the event of selecting the clothes.

The above are only preferred embodiments of the present disclosure, not any form of limitation to the present disclosure. Although the present disclosure has been disclosed as the preferred embodiments, it is not to be limited here. Any of those skilled in the art and familiar with the patent may make some changes or modifications for equivalent embodiments through the prompted technical content above without departing from the scope of the technical solution of the present disclosure. Any simple modification, equivalent change and modification to the above embodiments according to the technical essence of the present disclosure without departing from the technical solution of the present disclosure shall still belong to the scope of the solution of the present disclosure.

1. An intelligent dressing prompt device, being configured to be arranged on a clothes accommodating device, comprising:
a near-field identification module, being configured to read clothes information stored in an electronic label fixed on clothes in the clothes accommodating device; and
a control module, being connected with the near-field identification module and being configured to obtain dressing recommendation information and prompt a user according to the clothes information obtained by the near-field identification module.

2. The intelligent dressing prompt device according to claim 1, comprising a communication module, wherein the communication module is used for obtaining dressing condition information on which dressing recommendations are based by communication connection.

3. The intelligent dressing prompt device according to claim 2, wherein the communication module is used for obtaining current dressing fashion information and/or weather forecast information and/or dressing request information input by a user by communication connection, and sends information obtained to the control module as the dressing condition information referred to by the control module in a process of obtaining the dressing recommendations;
wherein the dressing request information input by the user comprises clothes application scene information, season information and clothes matching and style information.

4. The intelligent dressing prompt device according to claim 1, comprising a cloud server, wherein the control module is connected with the cloud server through the communication module, the cloud server is in communication connection with an intelligent terminal, and the cloud server is used for sending dressing fashion information and/or the weather forecast information to the communication module and/or the intelligent terminal, then receiving the dressing recommendation information sent by the control module and pushing the dressing recommendation information to the intelligent terminal to prompt the user.

5. The intelligent dressing prompt device according to claim 1, wherein the electronic label stores a clothes information code corresponding to clothes, the clothes information code is a total information code formed by series combination of sub codes representing different attribute information of clothes, respectively; the control module receives the clothes information code stored in the electronic label sent by the near-field identification module, then separately divides the clothes information code into the sub codes, and matches specific information of each sub code to obtain specific clothes information represented by the clothes information code.

6. The intelligent dressing prompt device according to claim 5, comprising a storage module, wherein the storage module is configured to store a corresponding relationship between each specific sub code and specific clothes attribute information represented by each specific sub code, and the control module obtains specific attribute information represented by each sub code in the clothes information codes according to the corresponding relationship.

7. A wardrobe with the intelligent dressing prompt device according to claim 1, comprising a wardrobe body being configured to store clothes, wherein the near-field identification module is arranged inside the wardrobe body, and transmits a radio frequency signal covering an entire interior space of the wardrobe body, and the control module and the communication module are arranged inside or outside the wardrobe body;
wherein the wardrobe comprises a display device configured to display the dressing recommendation information.

8. A control method applied to the wardrobe according to claim 7, comprising: controlling, by the control module, the near-field identification module to obtain the clothes information of all clothes in the wardrobe after receiving the dressing condition information; and
performing data analysis and processing according to the dressing condition information and the clothes information to obtain the dressing recommendation information that meets a dressing condition and prompt the user.

9. The control method applied to the wardrobe according to claim 8, wherein the dressing condition information comprises clothes application scene information input by the user, and the control module obtains the dressing recommendations according to the clothes application scene information.

10. The control method according to claim 8, wherein the control module obtains a plurality of dressing schemes for the user to select according to the dressing condition information, and the control module analyzes dressing preferences of the user according to the dressing schemes selected by the user, and optimizes the dressing schemes according to the dressing preferences of the user.

11. The control method according to claim 10, wherein
the control module arranges the dressing schemes in a descending order according to the preferences of the user and recommends the dressing schemes to the user.

12. The control method according to claim 11, wherein the control module recommends new style clothes that meet preferences of the user to the user according to the preferences of the user, and prompts the user to select and purchase.

13. The control method according to claim 9, wherein the control module generates the dressing recommendation information and/or dressing matching recommendation information and/or clothes purchase recommendation information according to season information and/or temperature information and/or rainfall capacity information and/or snowfall capacity information in weather forecast information in combination with clothes information, and pushes the dressing recommendation information to a display device or the intelligent terminal to prompt the user.

14. The control method according to claim 13, wherein the control module judges whether the weather forecast information meets preset triggering conditions, and if a result is yes, the control module controls to obtain the dressing recommendation information and prompt the user.

15. The control method according to claim 13, wherein the control module generates dressing parameters according to the weather forecast information, wherein the dressing parameters comprise different attribute information of clothes; the control module compares and matches the dressing parameters with clothes information of all clothes in a wardrobe, then obtains at least one piece of clothes with the clothes information matching the dressing parameters as target clothes, and pushes the clothes information of the target clothes to the user as dressing recommendations;
wherein when the target clothes with the clothes information matching the dressing parameters is not obtained, the user is prompted to purchase or add clothes, and the dressing parameters are pushed to the user as basis information for purchasing.

16. The control method applied to the wardrobe according to claim 9, wherein the dressing condition information further comprises current dressing fashion information and/or weather forecast information obtained by the communication module.

17. The control method according to claim 9, wherein the control module obtains a plurality of dressing schemes for the user to select according to the dressing condition information, and the control module analyzes dressing preferences of the user according to the dressing schemes selected by the user, and optimizes the dressing schemes according to the dressing preferences of the user.

18. The control method according to claim 12, wherein before the dressing recommendation information is obtained, the control module recommends the new style clothes that meet preferences of the user to the user according to new style clothes information obtained by the communication module, and prompts the user to select and purchase.

19. The control method according to claim 14, wherein a process in which the control module judges whether the weather forecast information meets preset triggering conditions, comprising: calculating a temperature change range, a rainfall capacity change range or a snowfall capacity change range in a period to come according to weather forecast information, judging whether the temperature change range, the rainfall capacity change range or the snowfall capacity change range reaches a preset change range; if a result is yes, the control module judges that the weather forecast information meets the preset triggering conditions, or otherwise, the control module judges that the weather forecast information does not meet the preset triggering conditions.
